(19) United States
(12) Patent Application Publication
(10) Pub. No.: US 2018/0138781 A1
(43) Pub. Date: May 17, 2018

(54) PERMANENT WATER MOTOR

(71) Applicant: Taiping ZHONG, Yueyang (CN)

(72) Inventor: Taiping ZHONG, Yueyang (CN)

(21) Appl. No.: 15/870,697

(22) Filed: Jan. 12, 2018

Related U.S. Application Data
(63) Continuation of application No. PCT/CN2016/088055, filed on Jul. 1, 2016.

(30) Foreign Application Priority Data
Sep. 15, 2015 (CN) 201510581236.3
Sep. 15, 2015 (CN) 201610020729.4

(51) Int. Cl. H02K 7/14; H02K 53/00; F03B 17/06; F24F 11/88; F24F 11/89

(52) U.S. Cl. CPC H02K 7/14; H02K 53/00; F24F 11/89; F24F 11/88; F03B 17/06

(57) ABSTRACT

A permanent water motor includes a battery (1), a permanent oil-pressure water-circulation vertical generator (2), an air conditioner (4) and an electric motor (3) which are integrated into a whole, wherein the battery is applied for start; the oil-pressure water-circulation permanent vertical generator is used to generate electricity; then the generated electricity is used to drive the air conditioner and the electric motor; and water discharged from the air conditioner is used as water energy of the generator for volatilization and supplementation, so that the permanent water motor is operated. The permanent water motor only relies on the water energy for support, and does not need any support from any other energy or any other external force. The electricity generated by the permanent water motor can drive various worldwide machines to permanently operate based on human needs.

### TECHNICAL FIELD

The present disclosure discloses a permanent water motor which is a new advanced main engine integrated by a battery, a permanent oil-pressure water-circulation vertical generator (the applicant has applied a Chinese patent application No. 201510325801.X for the generator), an air conditioner and an electric motor into a whole, wherein the battery is applied to starting; the oil-pressure water-circulation permanent vertical generator is used to generate electricity, while the electricity is used to drive the air conditioner and the electric motor; and water discharged from the air conditioner is used as water energy of the oil-pressure water-circulation permanent vertical generator for volatilization and supplementation. In this way, the permanent water motor of the present disclosure is operated without support from any other energy or any other external force. The water energy is relied on for support, and the electricity is relied on to drive various machines all over the world. The permanent water motor is permanently operated according to human needs, and supporting expense is zero.

(Note: battery+generator+air conditioner+electric motor=permanent water motor permanent water motor=water motor=permanent motor)

### BACKGROUND

Nowadays, electric motors, diesel engines and gasoline engines have been popularized worldwide. However, these main engines are single in action and inconvenient in use. Moreover, a large amount of various energies are needed for support when the engines are operated. Possession of these energies has become human enormous pressure and burden. Especially, use of these energies also seriously damages and pollutes the environment, affects climatic change, greatly consumes human resources and material resources and causes an enormous influence on human generation. A permanent water motor is invented herein in order to solve these serious problems generated by people and required to be solved by people but cannot be solved for long.

### SUMMARY

The present disclosure discloses a permanent water motor which is a new advanced main engine formed by integrating a plurality of machines into a whole to drive permanent operation of various machines. The following technical solution is specifically adopted.

1. A permanent water motor, comprising a battery, a permanent oil-pressure water-circulation vertical generator, an air conditioner and an electric motor which are integrated into a whole, wherein the battery is used to start the oil-pressure water-circulation permanent vertical generator to generate electricity, and the electricity is used to drive the air conditioner and the electric motor; water discharged from the air conditioner is used as water energy of the generator for volatilization and supplementation; and the electric motor is used to drive various machines to permanently operate based on human needs.

2. The permanent water motor includes four functions. The first function is that the permanent water motor can be used especially as a generator. The second function is that the permanent water motor can be used especially as an air conditioner. The third function is that the permanent water motor can be used especially as a main engine. The four function is that the generator in the permanent water motor generates electricity outwards, the air conditioner outputs air outwards and the main engine drives other machines to permanently operate simultaneously.

3. The permanent water motor, wherein the permanent water motor is suitable for worldwide army, air force and navy and worldwide industries, and the supporting expense is none.

The present disclosure discloses a permanent water motor which is a new advanced main engine developed to apply to worldwide army, air force and navy and worldwide industries. The permanent water motor can be integrally handled flexibly, and is convenient in use. The permanent water motor can transcend, replace and eliminate all worldwide main engines: an electric motor, a diesel engine, a gasoline engine and other energy machines. The permanent water motor has four functions, and is unique in present world. The first function is that the permanent water motor can be used especially as a generator. The second function is that the permanent water motor can be used especially as an air conditioner. The third function is that the permanent water motor can be used especially as a main engine. The four function is that the generator in the permanent water motor generates electricity outwards, the air conditioner outputs air outwards and the main engine drives other machines to permanently operate simultaneously. The operation of the permanent water motor does not need support from any other energy or any other external force. The operation of the permanent water motor does not have any negative effect on people, air, environments, climates, animals or plants, and the supporting expense is zero. The permanent water motor is the only preferred choice for people to adopt.

If four disclosure applications from the applicant, which are respectively 1. full automatic multi-emergency blocking type brake, 2. static water circulation electricity generation and drought and waterlogging resistance, 3. oil-pressure water-circulation permanent vertical generator, and 4. permanent water motor, can be comprehensively applied in time, applicant personally thinks that four problems would have been thoroughly solved around the world. Firstly, the problem is solved that it is difficult to completely eliminate worldwide traffic accidents of car crash on the road. Secondly, the problems are solved of satisfying annual production and living water worldwide and of difficult management and control of drought and waterlogging (except for seaquake and flood over levee). Thirdly, the problem is solved that it is difficult to transcend, replace and thoroughly eliminate all other energies as long as a small number of fixed water energy is used worldwide. Fourthly, the problems are solved of difficulty in eliminating heat generated by energy and emitting exhaust gas due to the worldwide use of the energy, controlling the reduction of earth temperature and optimizing environments.

### BRIEF DESCRIPTION OF THE DRAWINGS

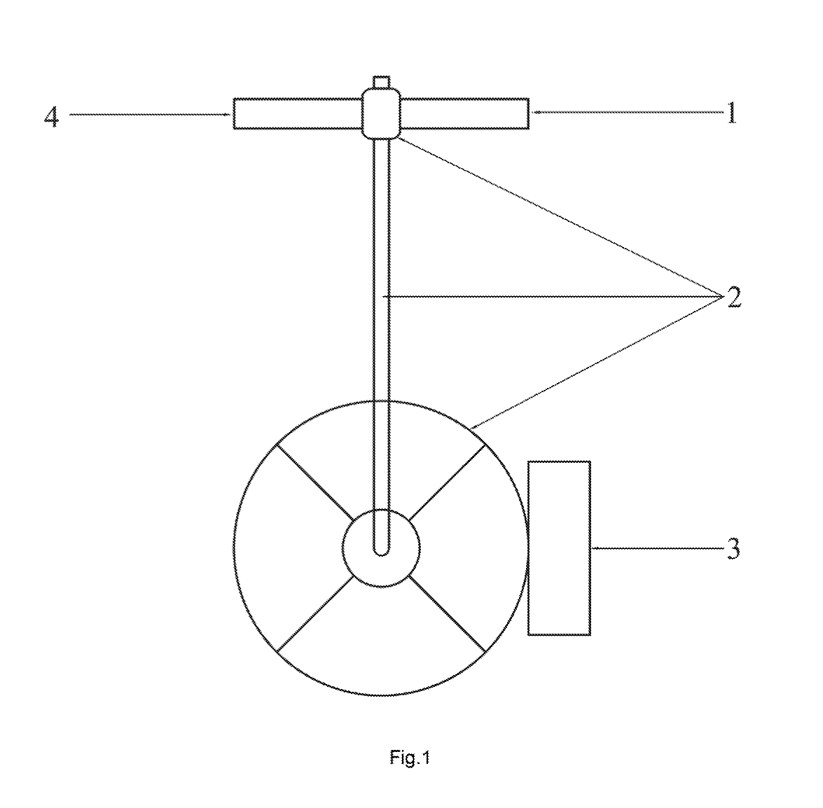

FIG. 1 shows a schematic diagram of the device of the present disclosure, wherein,
1 indicates the battery;
2 indicates the permanent oil-pressure water-circulation vertical generator;
3 indicates the electric motor; and
4 indicates the air conditioner.

### DETAILED DESCRIPTION OF THE DISCLOSURE

In the FIGURE, the battery 1 is fixed to the right side of the upper end of the generator 2; the electric motor 3 is fixed to the right side of the lower end of the generator 2; and the air conditioner 4 is fixed to the left side of the upper end of the generator 2. However, the battery 1 is used to start the generator 2 to generate electricity. The electricity is used to drive the air conditioner 4. Water discharged from the air conditioner 4 is used as water energy of the generator 2 for volatilization and supplementation. Meanwhile, the electricity is used to drive the electric motor 3, and the electric motor 3 is used to drive other machines to permanently operate according to human needs.

What is claimed is:

1. A permanent water motor, comprising
a battery, a permanent oil-pressure water-circulation vertical generator, an air conditioner and an electric motor integrated into a whole, wherein
the battery is used to start the permanent oil-pressure water-circulation vertical generator to generate electricity;
the electricity is used to drive the air conditioner and the electric motor;
water discharged from the air conditioner is used as water energy of the generator for volatilization and supplementation; and
the electric motor is used to drive various machines to permanently operate based on human needs.

2. The permanent water motor according to claim 1, wherein
the permanent water motor comprises four functions, wherein
firstly, the permanent water motor can be used especially as a generator;
secondly, the permanent water motor can be used especially as an air conditioner;
thirdly, the permanent water motor can be used especially as a main engine; and
fourthly, the generator in the permanent water motor generates electricity outwards, the air conditioner outputs air outwards and the main engine drives other machines to permanently operate simultaneously.

3. The permanent water motor according to claim 1, wherein
the permanent water motor is suitable for all industries, and supporting expense is zero.
